(19) United States
(12) Patent Application Publication
(10) Pub. No.: US 2003/0140048 A1
(43) Pub. Date: Jul. 24, 2003

(54) Tracking EDI documents with information from multiple sources

(76) Inventors: Matthew J. Meier, Delaware, OH (US); Stephen F. Campisano, Dublin, OH (US); Timothy Deaves, Toronto (CA); Steven A. Gingerich, Plain City, OH (US); Kedar R. Oke, Hilliard, OH (US)

Correspondence Address: STANDLEY & GILCREST LLP, 495 METRO PLACE SOUTH, SUITE 210, DUBLIN, OH, 43017, US

(21) Appl. No.: 10/378,343

(22) Filed: Mar. 3, 2003

Related U.S. Application Data
(63) Continuation of application No. 09/413,086, filed on Oct. 6, 1999.

(51) Int. Cl. G06F 7/00; G06F 17/30

(52) U.S. Cl. 707/10

(57) ABSTRACT

A method executed in a server system is provided for transmitting one or more outbound EDI documents in an EDI network, each outbound EDI document containing a respective unique document identifier. The method includes the generation of formatted files containing a document identifier and a translator machine capable for translating the formatted files into EDI documents. Another method translates inbound EDI documents by generating formatted files containing a document identifier comprising values extracted from each inbound EDI document.

### CROSS REFERENCE TO RELATED APPLICATIONS

This application is a continuation of application Ser. No. 09/413,086, filed Oct. 6, 1999, for TRACKING EDI DOCUMENTS WITH INFORMATION FROM MULTIPLE SOURCES, which is expressly incorporated herein by reference.

### BACKGROUND OF THE INVENTION

1. Field of the Invention

The present invention relates generally to the field of inventory management. More particularly it concerns a method for tracking EDI (Electronic Data Interchange) documents with information from multiple sources.

2. Description of Related Art

EDI is generally concerned with facilitating communication between businesses and trading partners. Generally speaking, business transactions between a buyer and a supplier are traditionally initiated by the buyer generating a paper purchase order for goods in view of its anticipated needs. The purchase order contains the information necessary for a supplier to complete the requested transaction, such as the identity of the buyer, the location of the supplies are need, and the date the supplies are wanted.

The purchase order is mailed, sent via facsimile, etc., from the buyer to the supplier. When the supplier receives the purchase order, the supplier enters the purchase order into its system manually to determine the availability of the ordered supplies.

If the supplies are available, the order is entered in the supplier's shipping system. The shipping system generates a paper invoice that is sent back to the buyer. The buyer finds out if his purchase order has been accepted and approximately when the order will arrive when the paper invoice arrives. It could take several days before the paper invoice is actually received by the buyer. If the invoice is sent via facsimile, the invoice could arrive within a few minutes of being sent. In either case it is necessary to manually enter the shipping information into the buyer's system. After the invoice is sent, the supplier initiates its shipping procedures so that the supplies can be transported to the buyer.

The traditional paper based process tends to be inefficient. Delays and backlogs in the mail system can extend the duration of the process to several days or even weeks. Furthermore, manual entry of information received on paper is prone to mistakes.

The demand for faster and more efficient business transactions has led to the development of EDI. EDI has been used to streamline the ordering and purchasing process between a supplier and a buyer. It may be appreciated that EDI is useful to facilitate all types of business transactions where data is exchanged.

Generally, EDI consists of the electronic exchange of information coded into predefined units, referred to as “documents,” between two or more business partners. EDI documents are defined to contain all the information that is necessary to exchange to conduct specific business transactions.

EDI is also concerned with the establishment of an open environment where an entire community of business partners can communicate. To foster seamless communication EDI documents have been standardized. The American National Standards Institute (ANSI) Accredited Standards Committee X.12 developed the Electronic Data Interchange ASC X.12 Standards, incorporated herein by reference as general background information, setting common standards for these documents and data elements that form part of each type of document.

FIG. 1 shows a typical EDI network including a buyer system 100, a value added network (VAN) 110, and multiple supplier systems 120. The buyer system 100 includes computer processing hardware 150 and EDI software 140. The Baan Company, for example, provides commercial system software solutions that manage information contained on EDI documents provided between buyers and suppliers (referred to herein as the “EDI software”).

The VAN 110 is a network generally provided by a third party to enable EDI document communications between the buyer system 100 and the supplier system 120. The VAN 110 provides an open environment where businesses can exchange EDI documents with the entire trading community in the EDI network. As will be appreciated by one skilled in the art, one purpose of the VAN 100 is to serve as an electronic mailbox to link the buyer system 100 and a supplier system 120. The buyer system 100 is connected to the VAN 112 via a communications link 130. The communications link 130 typically consists of leased lines from a common carrier using Transmission Control Protocol/Internet Protocol (TCP/IP) for connectivity. As will be appreciated by one skilled in the art, other types of communication links may be utilized. Likewise the supplier system is connected to the VAN via a communications link 130.

Typical use of the EDI network includes, for example, the buyer system 100 sending a Purchase Order document (sometimes known as an “850” document) to the VAN 110. The 850 document may be addressed to one or more suppliers and is coded according to X.12 standards to include appropriate information identifying the supplier and the supplies that are ordered. The 850 document can be sent to a supplier on a regular basis or on a need-based schedule. The 850 document can be sent to a supplier on a regular basis or on a need-based schedule. An 850 document can also be sent on a different schedule based on the specific supplier addressed.

The supplier 120 periodically checks for its EDI documents in the VAN 110. The supplier system 120 verifies that it can process the 850 document and responds with an Advanced Shipment Notice document (sometimes known as an “856” document) to the VAN 110 addressed to the buyer system 100.

The buyer system 100 periodically checks with the VAN 110 for its documents and will therefore retrieve the 856 document. The buyer system's 100 EDI software 140 validates the information in the 856 document and if appropriate returns an Application Advice document (sometimes known as an “824” document).

In a manufacturing environment a buyer commonly needs an efficient system to meet internal requirements. These internal requirements can include, e.g., a rigorous timing schedule between the sending and receiving of EDI documents. For example, to speed the delivery of needed suppliers, the buyer may set an internal requirement of only a few minutes for responding to 856 documents with an 824 program. Although in this example 824 and 856 documents are high priority documents, other documents that are periodically exchanged have a lower priority and do not require such a quick response time. For example, a Purchase Schedule document (sometimes known as an “830” document) may go out only once a week and thus there is no urgent need for an immediate delivery. Processing each of the EDI documents as they become available becomes inefficient because messages with a lower priority will at times be processed ahead of messages with a higher priority.

The business community that a buyer may need to exchange EDI documents with could be extensive. As shown in FIG. 1, the buyer may be purchasing goods from a plurality of suppliers 120. However, the buyer may also need to exchange EDI documents with businesses such as financial institutions, freight services, warehouses, etc. The buyer may also have a plurality of internal departments and organizations that originate purchases, sometimes known as “logistical companies.” These logistical companies are interested in independently finding the status of a specific purchase order. In order to manage the EDI network the buyer needs to be fully aware of the status of the EDI documents originated by its logistical companies and received from its suppliers and other business partners.

Thus, there exists a need to track EDI documents that is uniform to the buyer, its logistical companies, and to other business partners such as suppliers. A need further exists for a tracking method that displays the status of each EDI business transaction to determine its status.

### SUMMARY OF THE INVENTION

One aspect of the present invention relates to a method, executed by a server system in an EDI network, of transmitting one or more EDI documents, referred to as outbound EDI documents. Each outbound EDI document contains a respective unique document identifier. The method comprises providing a translator machine that is programmed to translate files structured in accordance with a specified format, referred to as formatted files, into corresponding outbound EDI documents. The method also provides instructions to the translator machine for embedding the respective document identifiers of formatted files into corresponding transmission identifier fields of the respective corresponding outbound EDI documents. The method also generates the one or more formatted files containing information to be included in the one or more outbound EDI documents to be transmitted, including respective document identifiers and sending the one or more formatted files to the translator machine.

In another aspect of the invention, the document identifiers of the outbound EDI documents are used to track the status of the outbound EDI documents. The outbound EDI documents can be displayed to track their respective status.

Yet another aspect of the present invention relates to a method, executed by a translator machine in an EDI network, of translating inbound EDI documents into files structured in accordance with a specified format, referred to as formatted files. The method generates one or more inbound formatted files containing information from one or more inbound EDI documents. For each of the one or more inbound EDI documents, a respective document identifier is also generated. The one or more formatted files are then sent to a server system. The document identifier can be used to track the status of the inbound EDI documents including the displaying of the status.

### BRIEF DESCRIPTION OF THE DRAWINGS

The following drawings form part of the present specification and are included to further demonstrate certain aspects of the present invention. The invention may be better detailed by reference to one or more of these drawings in combination with the detailed description of specific embodiments presented herein.

FIG. 1 is a block diagram of an EDI network.

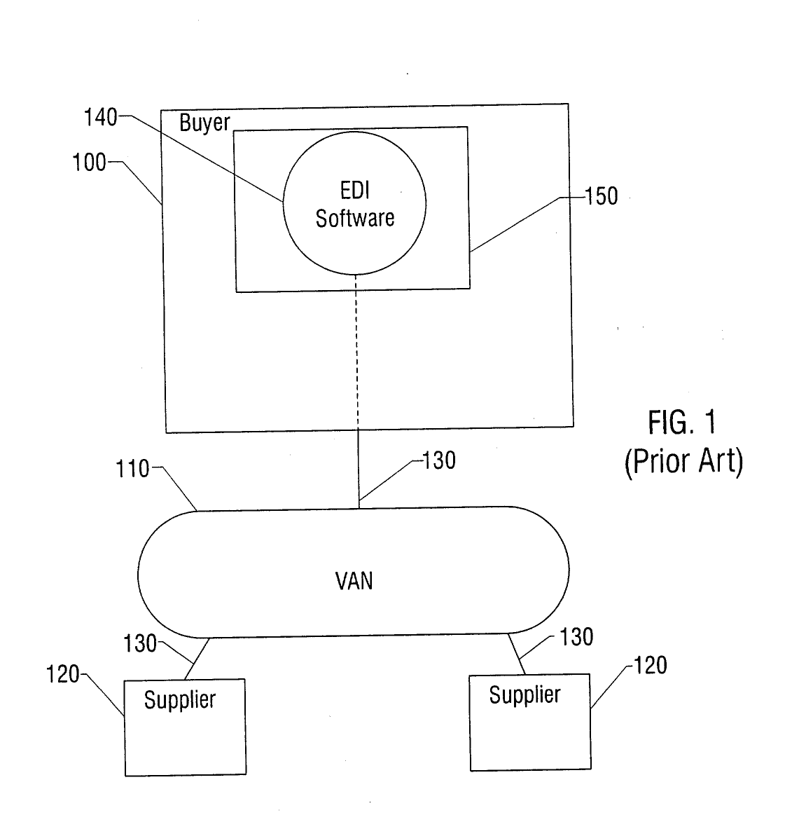

FIG. 2 is a high level block diagram of an exemplary embodiment of a server system in an EDI network.

FIG. 3 depicts an exemplary embodiment of a document identifier.

FIG. 4 is a block diagram of an embodiment of the present invention.

### DESCRIPTION OF ILLUSTRATIVE EMBODIMENT

For purposes of illustration, a specific embodiment is described below. In the interest of clarity, not all features of actual implementations are described in this specification. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention. Those of skill in the art will also appreciate that in the development of an actual implementation, as in any project, numerous engineering and programming decisions must be made to achieve the developers's specific goals. Development of such an implementation, although perhaps complex and time-consuming, would nevertheless be a routine undertaking for those of ordinary skill in the field of EDI system design and programming.

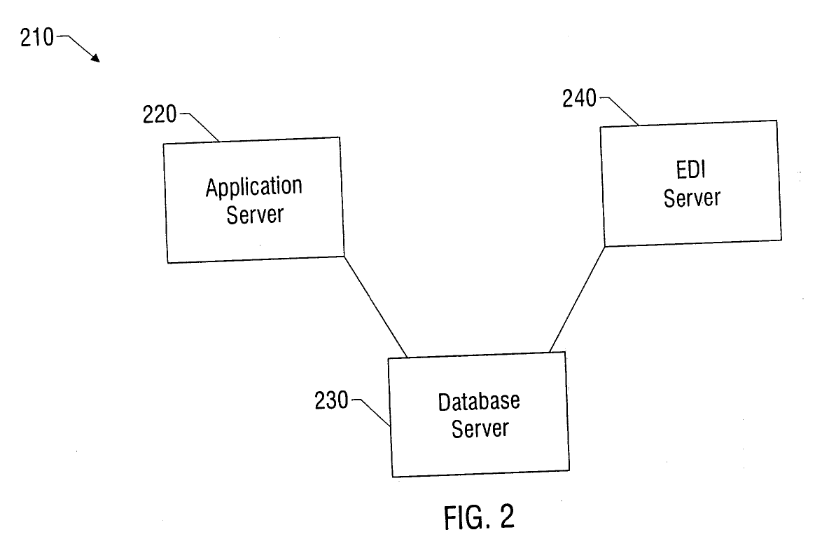

The illustrative embodiment includes a method, executed by a server system in an EDI network, of transmitting one or more EDI documents. Referring to FIG. 2, a server system 210 can comprise one or more actual machines. One typical implementation of a server system 210 involves an application server 220, a database server 230, and an EDI server 240. Each server may comprise any suitable hardware and software platform, e.g., a personal computer, a workstation, a mainframe computer, combinations thereof, etc. The servers may be interconnected via network links 250 or any other suitable interserver connection platform.

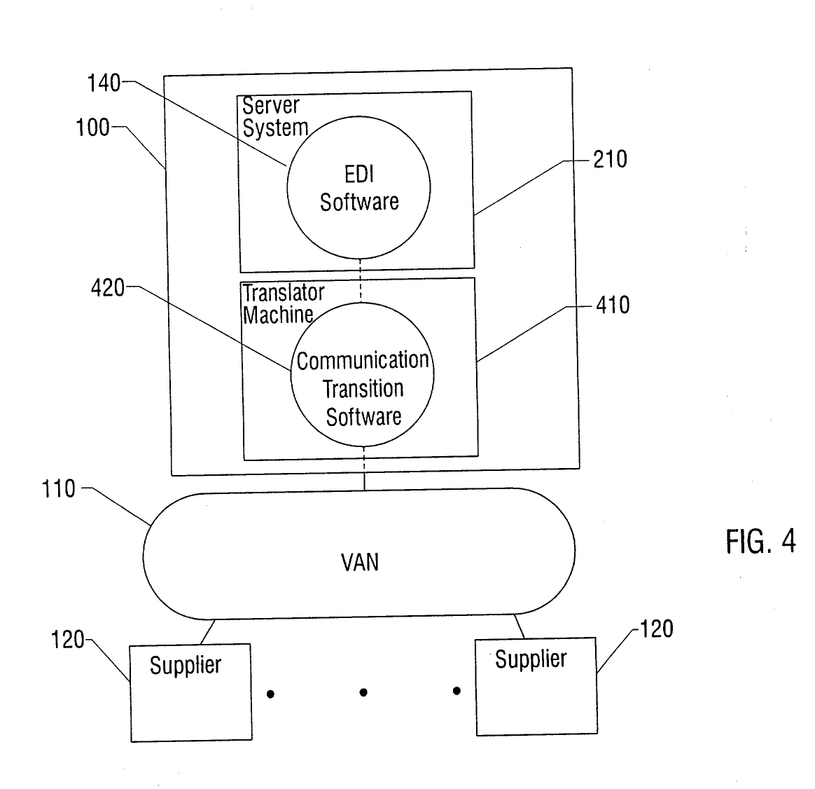

The server system 210 runs the EDI software 140. In one illustrative embodiment, shown in FIG. 4, the EDI software 140 is based on the Baan Company Software, commercially known as BaaN™ IV, modified to perform the methods of the present invention. The EDI software 140 utilizes separate communications/translation software 420 to interface with the VAN 110. In one illustrative embodiment, the communications/translation software 420 is based on modifications to Sterling Commerce's Gentran:Server product (referred to herein as “communications/translation software”).

The communications/translation software 420 provides the File Transfer Protocol (FTP) communication between the EDI software 140 and the VAN 110. The communications/translation software 420 also provides translation services coding EDI documents sent to the VAN 110 according to the X.12 standard and decoding the X.12 EDI documents taken from the VAN 110 for the EDI software 140.

In one exemplary embodiment EDI documents are referred to as “outbound” EDI documents when the EDI documents are generated by the buyer system 100 and are addressed to a supplier system 120 as shown in FIG. 4. One skilled in the art with the benefit of this disclosure will appreciate that the reference “outbound EDI document” could refer to an EDI document originating from a buyer, supplier, or other entity in an EDI network depending on the perspective of the embodiment being discussed.

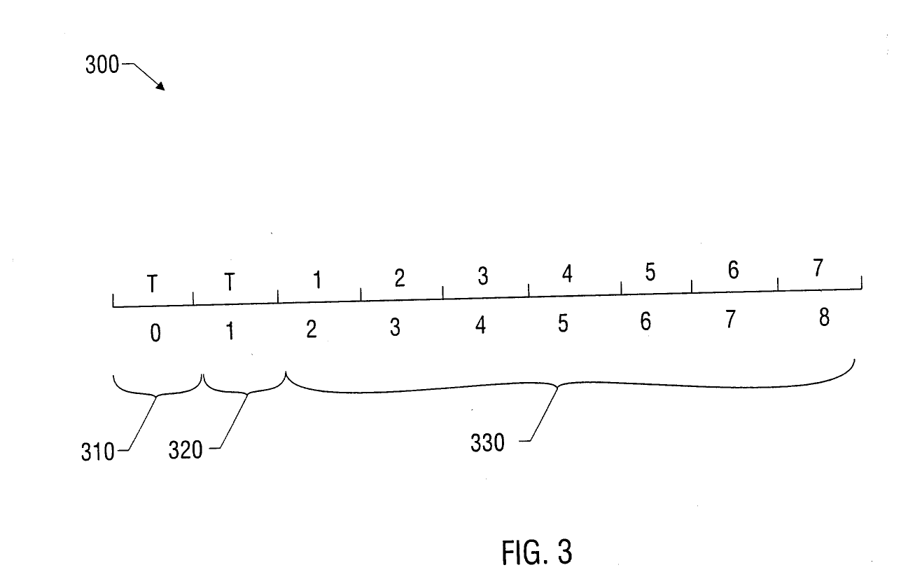

Each outbound EDI document originating from the buyer system 100 is assumed to contain a document identifier. The document identifier is used to uniquely identify each outbound EDI document throughout the EDI network and the buyer's logistical companies. FIG. 3 shows a specific embodiment for the document identifier 300. Because the document identifier 300 is embedded in a transmission identifier field of an outbound EDI document, it remains with the EDI document as the document is transmitted along the supply chain of the EDI network. Accordingly, the document identifier 300 can be used for tracking purposes.

In the illustrative embodiment shown in FIG. 3, the document identifier is made up of nine characters labeled 0-8. The document identifier includes two letters in character spaces 0-1. Space 0 310 specifies the logistical company that originates the EDI document. Space 1 320 specifies the type of EDI document.

The document identifier 300 also includes a seven digit number in spaces 2-8 330 specifying a sequential number for outbound EDI documents. For example, the document identifier TF1234567 can represent the 1,234,567^{th} document identifier (assuming that the sequential numbers are generated beginning at 0000001) for the document type designated as “F,” and the logistical company designated as “T.” A logistical company in the present embodiment refers to an internal division of the buyer, such as a particular manufacturing site that is a part of the buyer. For each two-letter combination of characters 0-1, a sequential number is kept in character locations 2-8. However, it will be appreciated that the form of the document identifier is not relevant to the invention.

As shown in FIG. 4, the method comprises providing a translator machine 410 that is programmed to translate files structured in accordance with a specified format, referred to as formatted files, into corresponding outbound EDI documents. Translate, for purposes of this specification, refers to receiving a file in a specified format and generating a corresponding file in a different format. The formatted files that are translated are also known colloquially as “flat files.”

The translator machine 410 may be a general-purpose computer running the communications/translation software 420. According to one embodiment, the translator machine 420 is a Hewlett-Packard® HP 9000 type of computer. It will be appreciated by one skilled in the art that the translator machine 410 may be a separate physical machine from the server system 210, or it may be the same machine running both the communications/translation software 420 and the server-system software.

The translator machine 410 is provided with instructions for embedding the respective document identifiers of formatted files into corresponding transmission identifier fields of the respective corresponding outbound EDI documents. In the ANSI X.12 standard, the transmission identifier field is referred to as the ST02 field. The document identifier 300 is created by the EDI software 140 and is converted into the transmission identifier by communications/translation software 420. Thus, the document identifier 300 for an EDI document originated by the server system 210 can be determined by simply checking the transmission identifier.

In order for the tracking mechanism to be complete, EDI documents taken from the VAN 110 and addressed to the buyer system 100 should also be uniquely identified and displayed. In the embodiment here described, EDI documents addressed to the buyer are referred to as “inbound” EDI documents. Therefore, according to an illustrative embodiment of the present invention, as shown in FIG. 4, a method is executed by a translator machine 410 in an EDI network of translating inbound EDI documents.

The EDI documents are translated by the communications/translation software 420 running in the translator machine 410 into one or more files structured in accordance with a specified format, again referred to as formatted files. The formatted files are generated and sent to the server system 210. The inbound formatted files contain information from one or more inbound EDI messages. The communications/translation software 420 creates an inbound document identifier for incoming documents based on information received in the inbound EDI document. According to one embodiment, the following information is extracted from an incoming X.12 EDI document and concatenated to generate the inbound document identifier: (1) logistical company identifier, identifying an internal entity (e.g. a manufacturing site) of the buyer; (2) the ISA Sender field, identifying the address of the sender; (3) the transaction set identification field (defined as ST01 in the X.12 standard); (4) the transmission identifier (defined as ST02 in the X.12 standard); (5) the ISA date, indicating the date the EDI document was sent from the supplier; and (6) the ISA time, indicating the time the EDI document was sent from the supplier.

Similar to the outbound side, the inbound side EDI document processing has a significant advantage in that it permits the information that is collected from an EDI document to be passed through from a supplier or other business partner to the buyer, and to the logistical companies within the buyer. Thus, the EDI document can be uniquely identified along with a variety of different information from databases that is collected, collated, and then displayed in any convenient format, because the document identifier is passed through.

In order to keep track of the EDI documents it is necessary to maintain a data store containing the respective document identifiers whose values are contained in each transmission identifier field for each respective one or more outbound EDI documents. Also, for each of a plurality of inbound EDI documents, a data store is maintained with the respective inbound document identifier, comprising a concatenation of a specified set of field values in the respective one or more inbound EDI documents. To display the status of the outbound and/or inbound EDI documents, the display may be organized by linking information about, or from, related EDI documents so that such information is displayed in a convenient format that shows the relationship(s) between the related documents as desired.

The method described in the illustrative embodiments may be implemented at least in part by one or more computer programs to be executed by one or more general-purpose processors. The programming may be accomplished through the use of a program storage system comprising one or more program storage devices readable by the processor(s) that encodes software, e.g., a program of instructions executable by the processor(s) for performing the operations described above. Any such program storage device may take the form of, e.g., read-only memory (ROM) installed on a circuit board containing the processor, as well as other forms of the kind well known in the art of subsequently developed. The program of instructions may be “object code,” i.e., in binary form that is executable more-or-less directly by the computer; in “source code” that requires compilation or interpretation before execution; or in some intermediate form such as partially compiled code. The precise forms of the program storage device(s) and of the encoding of instructions are immaterial here.

While methods of this invention have been described in terms of illustrative embodiments, it will be apparent to those of skill in the art that variations may be applied to the methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

What is claimed is:

1. A method, executed by a buyer server system in an EDI network, of transmitting one or more EDI documents, referred to as outbound EDI documents:
(a) generating at said buyer server system a unique document identifier for each of said outbound EDI documents;
(b) providing a translator machine that is programmed to translate files structured in accordance with a specified format, referred to as formatted files, into corresponding outbound EDI documents;
(c) providing instructions to the translator machine for embedding the respective document identifiers for tracking of formatted files into corresponding transmission identifier fields of the respective corresponding outbound EDI documents;
(d) generating one or more formatted files containing information to be included in the one or more outbound EDI documents to be transmitted, including respective document identifiers for tracking;
(e) sending the one or more formatted files to the translator machine;
(f) transmitting said outbound EDI documents from said buyer server system to one or more supplier EDI networks; and
(g) using the respective document identifiers of one or more outbound EDI documents at one or more of said supplier EDI networks in determining the status of one or more outbound EDI documents.

2. The method of claim 1, further comprising displaying at said buyer server system the status of at least some of said one or more outbound EDI documents.

3. A method, executed by a translator machine in an EDI network, of translating inbound EDI documents into files structured in accordance with a specified format, referred to as formatted files, and transmitting said formatted files to a server system, said method comprising:
(a) generating one or more inbound formatted files containing (1) information from one or more inbound EDI documents, and (2) for each said one or more inbound EDI documents, a respective document identifier for tracking;
(b) storing in a data store each of said respective document identifiers;
(c) sending the one or more formatted files to the server system; and
(d) displaying at the server system the status of one or more inbound EDI in accordance with said document identifiers in said data store.

4. The method of claim 3, wherein the respective document identifier for each of the one or more inbound EDI documents comprises a concatenation of a specified set of field values in the respective one or more inbound EDI documents.

5. The method of claim 4, wherein the specified set of field values comprise 1) a logistical company number, 2) a sender address value, 3) a transaction set ID value, 4) a transmission identifier value, 5) a date-created value, and 6) a time-created value.

6. The method of claim 5, wherein the one or more inbound EDI documents are structured in accordance with the ANSI X.12 format.

7. The method of claim 3, further comprising:
(e) using the respective document identifiers of one or more inbound EDI documents in determining the status of one or more outbound EDI documents, and (f) displaying the status of at least some of said one or more outbound EDI documents.

8. A machine-executed method of tracking the status of one or more EDI documents, comprising:
(a) providing a data store containing:
(1) for each of one or more outbound EDI documents, a respective document identifier for tracking comprising a concatenation of a specified set of field values in the respective one or more outbound EDI documents, and
(2) for each of a plurality of inbound EDI documents, a respective document identifier for tracking comprising a concatenation of a specified set of field values in the respective one or more inbound EDI documents;
(b) using the respective document identifiers in the data store in determining the status throughout a buyer's EDI supply chain of one or more of the inbound EDI documents and outbound EDI documents, and
(c) displaying the status of at least some of said one or more outbound EDI documents and inbound EDI documents.
